(19) United States
(12) Patent Application Publication
(10) Pub. No.: US 2022/0159401 A1
(43) Pub. Date: May 19, 2022

(54) IMAGE-BASED SOUNDFIELD RENDERING

(71) Applicant: Hewlett-Packard Development Company, L.P., Spring, TX (US)

(72) Inventors: Sunil Bharitkar, Palo Alto, CA (US); Eric Faggin, Palo Alto, CA (US); Madhu Athreya, Palo Alto, CA (US)

(73) Assignee: Hewlett-Packard Development Company, L.P., Spring, TX (US)

(21) Appl. No.: 17/433,017

(22) PCT Filed: Jun. 21, 2019
(86) PCT No.: PCT/US2019/038598

§ 371 Date: Aug. 23, 2021

(51) Int. Cl. H04S 7/00; G06T 7/70; G06V 40/10; G06V 20/50; H04R 5/02; H04R 5/04; H04R 1/02; H04N 13/207

(52) U.S. Cl. CPC H04S 7/303; G06T 7/70; G06V 40/103; G06V 20/50; H04R 5/02; G06T 2207/10016; H04R 1/028; H04N 13/207; G06T 2207/30196; H04R 2499/15; H04R 5/04

(57) ABSTRACT

An audio control system may include an imaging sensor to capture an image of an environment containing loudspeakers connected to the audio control system. A listening position subsystem may process the captured image to identify a listening position within the environment. A speaker position subsystem may process the captured image to determine a physical location of each loudspeaker relative to the identified user listening position. A signal processing subsystem may modify an output signal driving the loudspeakers to steer a soundfield generated by the loudspeakers. The audio control system may include a processor, memory, and/or hardware components to implement the various subsystems such that, at the identified user listening position, a perceived location of one of the loudspeakers is mapped to a location that is different than its physical location.

### BACKGROUND

Audio control systems strive to produce distortion-free and/or accurate audio reproductions. The physical placement of loudspeakers relative to listeners impacts the ability of the audio control system to meet these goals. Standards such as those defined by the International Telecommunications Union (ITU), Dolby Laboratories, THX LTD, and others guide the placement of loudspeakers relative to listeners to achieve good results.

Due to environmental constraints, such as room size, furniture placement, and/or listener preferences, the physical placement of loudspeakers may not comply with the ITU, Dolby Laboratories, THX LTD, or other standards. Lack of compliance with a standard may lead to an inferior listener experience.

### BRIEF DESCRIPTION OF THE DRAWINGS

Non-limiting and non-exhaustive examples of the disclosure are described in conjunction with the figures described below.

FIG. 1 illustrates an example target topographical layout for loudspeakers relative to a user listening position.

FIG. 2A illustrates an example view of an environment comprising furniture, video components, audio control systems, and/or loudspeakers.

FIG. 2B illustrates an example view of an environment comprising furniture and/or loudspeakers.

FIG. 3 illustrates a flow diagram of an example of a deep learning model to identify objects within an image.

FIG. 4 illustrates an example of a physical topographical layout of loudspeakers relative to an identified user listening position that does not comply with a standard layout.

FIG. 5 illustrates a flowchart of an example method for adjusting an audio control system to modify a listener experience.

FIG. 6A illustrates an example set of loudspeakers with various enclosure sizes, enclosure types, driver sizes, brand names, and models.

FIG. 6B illustrates an example close-up view of a loudspeaker with its brand name visible.

FIG. 7 illustrates a block diagram of an example for determining the distance from an imaging system to an individual.

FIG. 8 illustrates an example of a listener and a marker captured in an image by an imaging system.

FIG. 9 illustrates an example of a table captured in an image by an imaging system.

### DETAILED DESCRIPTION

Audio control systems can be configured to produce distortion-free and/or accurate audio reproductions. The physical placement of loudspeakers relative to listeners impacts the ability of the audio control system to meet these goals. Standards such as those defined by the International Telecommunications Union (ITU), Dolby Laboratories, THX LTD, and others guide the placement of loudspeakers relative to listeners to achieve good results.

Due to constraints in an environment such as room size, furniture placement, and/or listener preferences, the physical placement of loudspeakers may not comply with an established standard. Lack of compliance with standards may lead to an inferior listener experience. According to the systems and methods described herein, audio control systems may adjust drive outputs connected to loudspeakers to modify the generated soundfield to mimic or simulate a standards-based physical loudspeaker placement. The soundfield may cause a listener to perceive the speakers in a standard layout, which may improve listener experience and/or facilitate a more accurate reproduction of an intended audio composition.

As described herein, an audio control system may include an imaging sensor to capture an image of an environment containing loudspeakers connected to the audio control system. A listening position subsystem may process the captured image to identify a listening position within the environment. A speaker position subsystem may process the captured image to determine a physical location of each loudspeaker relative to the identified user listening position. A signal processing subsystem may modify an output signal driving the loudspeakers to steer a soundfield generated by the loudspeakers.

As an example, the audio control system may modify at least one of a directivity response, an on-axis frequency response, a frequency response, and a sound pressure level (SPL) parameter of any number of loudspeakers to attain a target soundfield that maps a perceived location of loudspeakers to the target layout. As a further example, modifying the drive outputs of the audio control system may include digital filtering and digital equalization prior to digital-to-analog conversion of the drive outputs used to drive the loudspeakers.

The audio control system may include a processor, memory, and/or hardware components to implement the various subsystems such that, at the identified user listening position, a perceived location of one of the loudspeakers is mapped to a location that is different than its physical location. In some examples, the audio control system may utilize computer-vision to identify objects in the environment, including couches, chairs, loudspeakers, and/or listeners. A distance measurement subsystem may measure a distance from each loudspeaker to the user listening position and/or between loudspeakers.

Some implementations may determine distances based on image analysis alone. Other implementations may utilize an ultrasonic distance measurement device and/or an optical time-of-flight measurement device. Still other implementations may utilize a microphone to measure test-tone delays. Image analysis may provide additional information, such as listener location, object detection, etc. that may not be available using test-tone or audio-only measurement approaches.

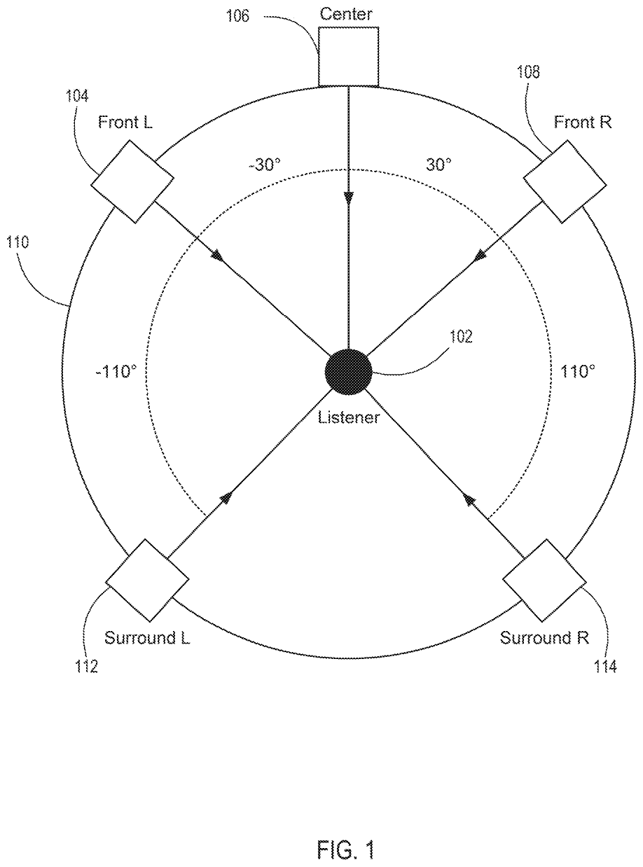

FIG. 1 illustrates an example target topographical layout that corresponds to one example of a standard layout for loudspeakers relative to a user listening position 102. In the illustrated example, there are five loudspeakers comprising Front L 104, Front R 108, Center 106, Surround L 112, and Surround R 114. Each loudspeaker is positioned on the periphery of an imaginary circle 110. The listener position 102 is at the center of the imaginary circle.

Standards bodies such as the International Telecommunications Union (ITU), Dolby Laboratories, THX LTD, and others recommend loudspeaker and listener layouts. Examples of recommended layouts include ITU-R BS.2159, Real 5.1, DTS, THX, ITU-R BS 775-1, and others.

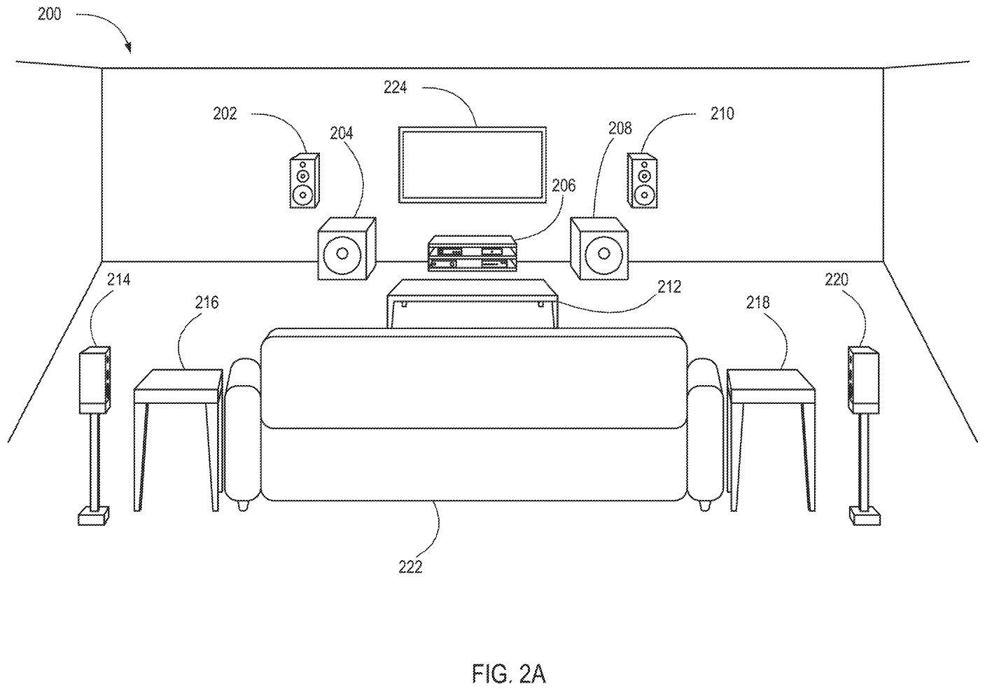

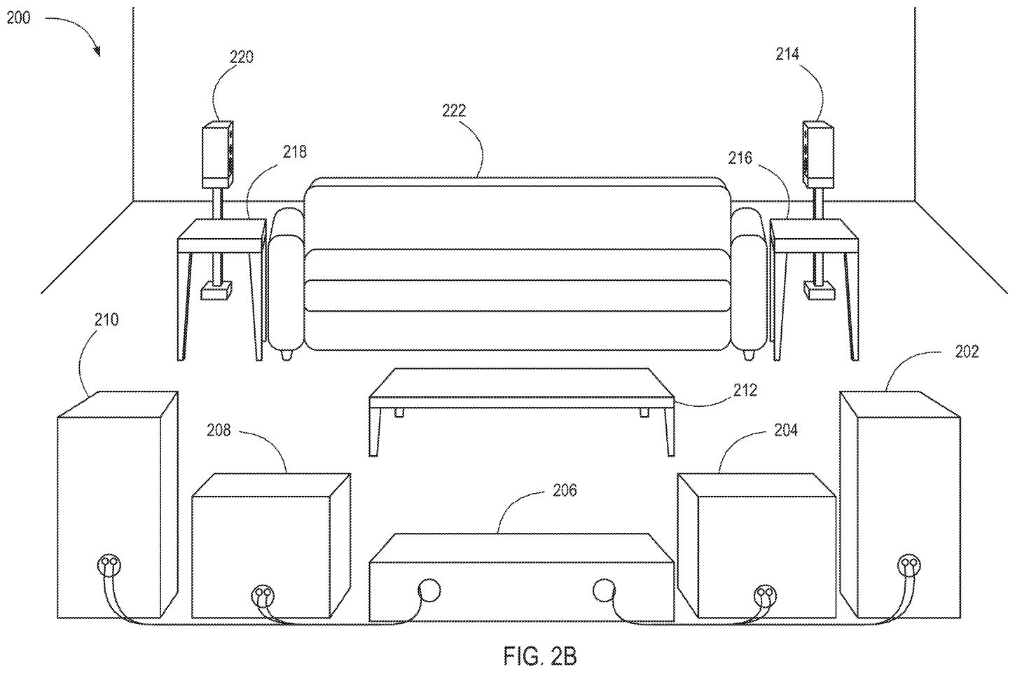

FIG. 2A illustrates an example of an environment 200 comprising furniture (e.g., 212, 216, 218, and 222), audio control systems 206, video components 224, and loudspeakers (e.g., 202, 204, 208, 210, 214, and 220). In some examples, video components 224 may be omitted for an audio-only setup. Due to various environmental constraints such as environment size, placement of furniture, and/or listener preferences, the loudspeakers and/or a listener may not be arranged in physical locations matching those of a standard layout. In addition, furniture type and/or placement may be intended for multiple listener positions within the environment, only one of which may comply with standards. Furthermore, a soundfield produced by the loudspeakers 202, 204, 208, 210, 214, and 220 may be modified by the room walls and/or furniture.

FIG. 2B illustrates an example of the environment 200 comprising furniture (e.g., 212, 216, 218, and 222), loudspeakers (e.g., 202, 204, 208, 210, 214, and 220), and/or audio control systems 206. This perspective may, for example, be captured using an imaging system, such as a still image camera and/or a video camera mounted on and/or included in a television, monitor, and/or in or on an audio control system. In other examples, stationary and/or mobile imaging systems may be employed.

In some examples, imaging systems may acquire still images, sequences of still images, and/or video. In some examples, imaging systems may acquire two-dimensional images, three-dimensional images, and/or images of higher dimensionality. In some examples, images may be acquired using visible and/or non-visible electromagnetic radiation.

In some examples, an audio control system 206 may receive manually acquired information (e.g., via a user-acquired image and/or user-defined layout) identifying the position and/or orientation of loudspeakers 202, 204, 208, 210, 214, and 220 and/or other objects within an environment (e.g., couches, chairs, tables, windows, walls, etc.). In some examples, the audio control system 206 may acquire position and/or orientation information of loudspeakers by evaluating a generated soundfield. In some examples, the audio control system 206 may determine object location using echolocation. In some examples, an audio control system 206 may facilitate the collection of position and/or orientation information through another mechanism, such as via Bluetooth, WIFI, and/or GPS systems.

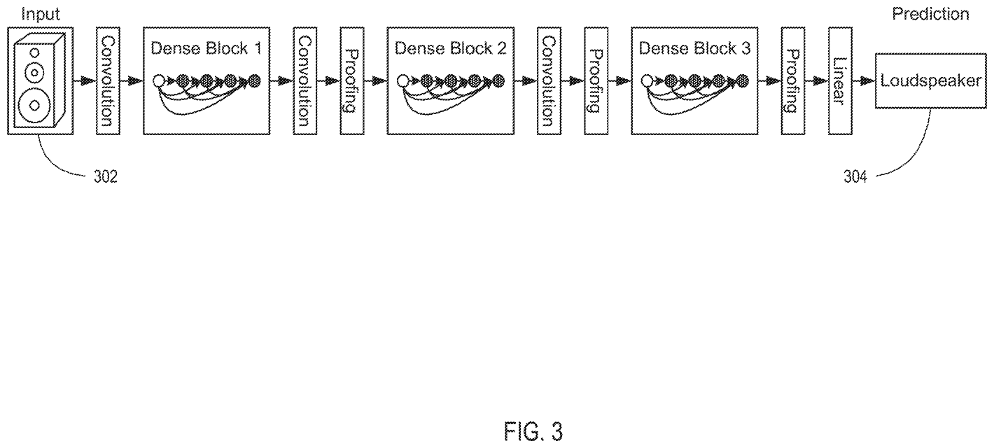

FIG. 3 illustrates an example of a deep learning model that, in some examples, is implemented by an audio control system. In some examples, the audio control system may utilize cloud-based or other remote computing to implement the deep learning model. The deep learning model receives as input 302 an image containing objects and identifies the object or objects therein. For example, an image of an environment comprising furniture, possible listener positions, and/or loudspeakers may be used as input to the deep learning model. The model may be used repeatedly to evaluate the scene depicted in the image to identify each type of object of interest. In other examples, the deep learning model may evaluate the scene depicted in the image for all objects of interest. In some examples, the model may identify listener positions, furniture, loudspeakers 304, and/or other objects of interest within the environment.

In some examples, the audio control system may utilize the illustrated, or another, deep learning model to identify objects. In some examples, other object detection and/or identification approaches may be used. Examples of other approaches include genetic evolution network models, neural network models, machine learning models, other artificial intelligence models, deterministic models, and/or other approaches. The illustrated deep learning model includes various convolutional and dense block layers. In various examples, a deep learning model may utilize a layer-pooling convolutional neural network approach for object detection and identification.

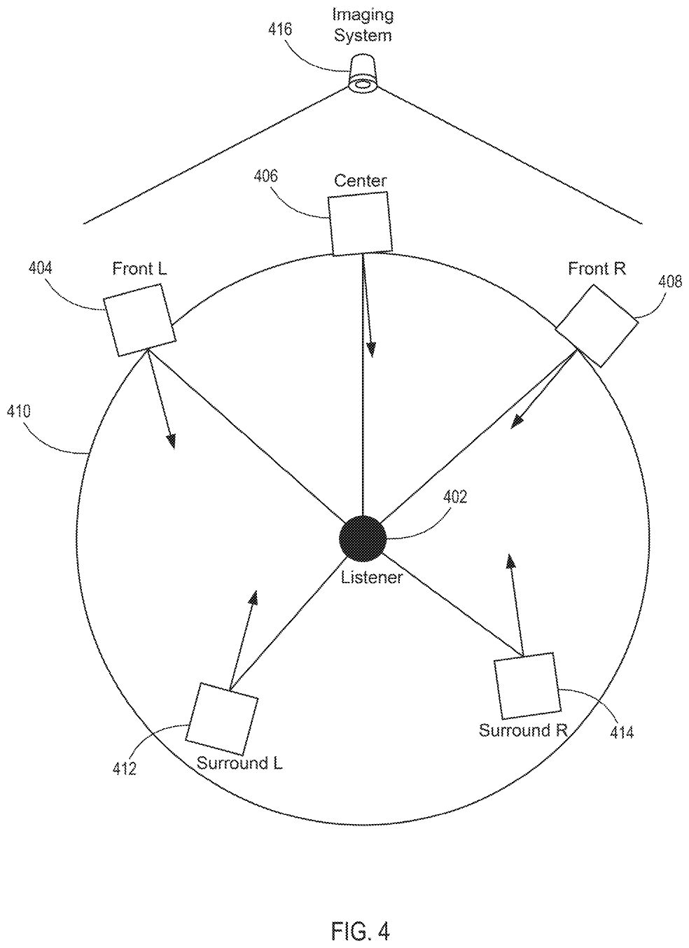

FIG. 4 illustrates an example of a physical topographical layout of loudspeakers 404, 406, 408, 412, and 414 relative to an identified user listening position 402 that does not comply with a standard layout. An imaging system 416 of an audio control system may acquire an image of an environment comprising furniture, loudspeakers, and/or other objects. In some examples, the imaging system may capture a single image. In other examples, the imaging system may capture a sequence of images and/or video.

In some examples, collected images may be used to determine the objects within the environment. For example, the processed images may identify the location and/or orientation of loudspeakers 404, 406, 408, 412, and 414 and/or listener position 402. In some examples, this information may be used to create a representation of the physical location of loudspeakers and listener positions and/or their positions relative to one another. In some examples, the positions of objects of interest relative to one another may be measured in two-dimensional space. In other examples, the dimensionality of the space of interest may be higher. For example, the audio control system may determine the relative positions of objects of interest in three-dimensional space. In various examples, the audio control system may determine locations relative to the listening position, a television or other video display, and/or an audio control system, such as an audio video receiver (AVR), an amplifier, an equalizer, or other audio processing and/or driving equipment.

In the illustrated example, the audio control system utilizes a deep learning model to identify the location and orientation of loudspeakers Front L 404, Front R 408, Center 406, Surround L 412, and Surround R 414. In addition, the deep learning model identifies a listener position 402. In this example, due to environmental constraints and/or listener preference, the relative position of the listener position 402 and loudspeakers 404, 408, 406, 412, and 414 do not comply with a standard layout.

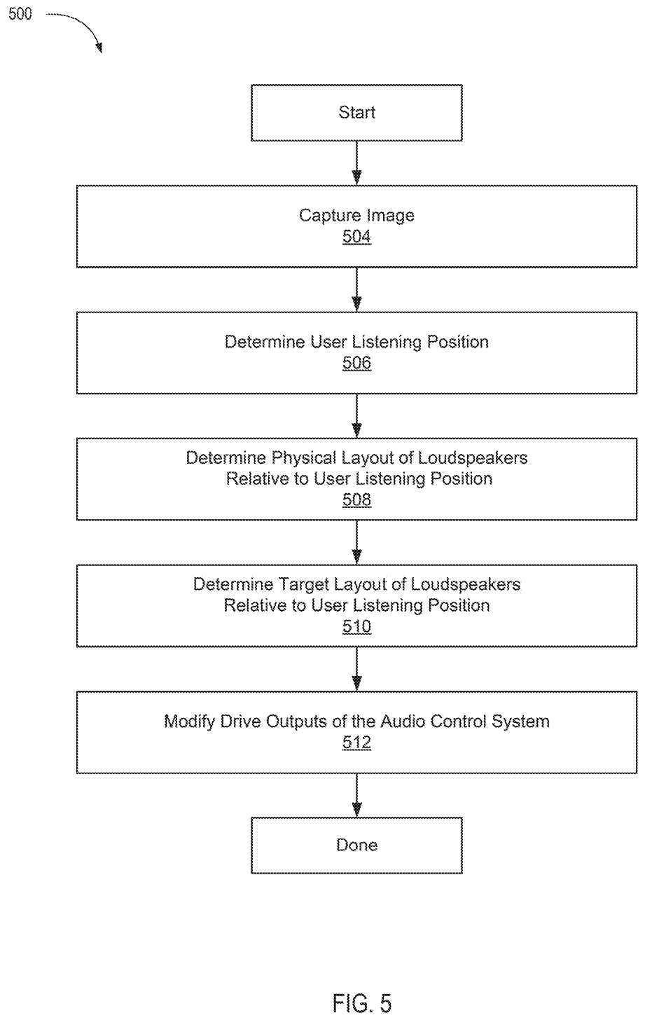

FIG. 5 illustrates a flowchart 500 example process for modifying the experience of a listener using a loudspeaker layout that does not comply with a standard layout. In some examples, the process begins with the acquisition of an image, or multiple images, of an environment 504 comprising furniture, audio control systems, loudspeakers, listener position, and/or other objects. In some examples, the audio control system processes the captured images using a deep learning model to determine and/or otherwise identify a listener position 506.

In some examples, the acoustic control system may further process acquired images (e.g., using a deep learning model) to determine the position and/or orientation of loudspeakers 508 relative to a listener position. In some examples, the position and/or orientation of loudspeakers relative to a listener position are compared to a standard loudspeaker layout 510. The acoustic control system may consider the standard loudspeaker layout a “target” or “goal” layout for the loudspeakers. The audio control system may adjust or filter the drive outputs 512 to modify the generated soundfield to mimic a standard loudspeaker layout. That is, the audio control system may modify the drive outputs 512 so that a listener in the determined user listening position (at 506) will perceive the loudspeakers as if they were laid out according to the standard loudspeaker layout.

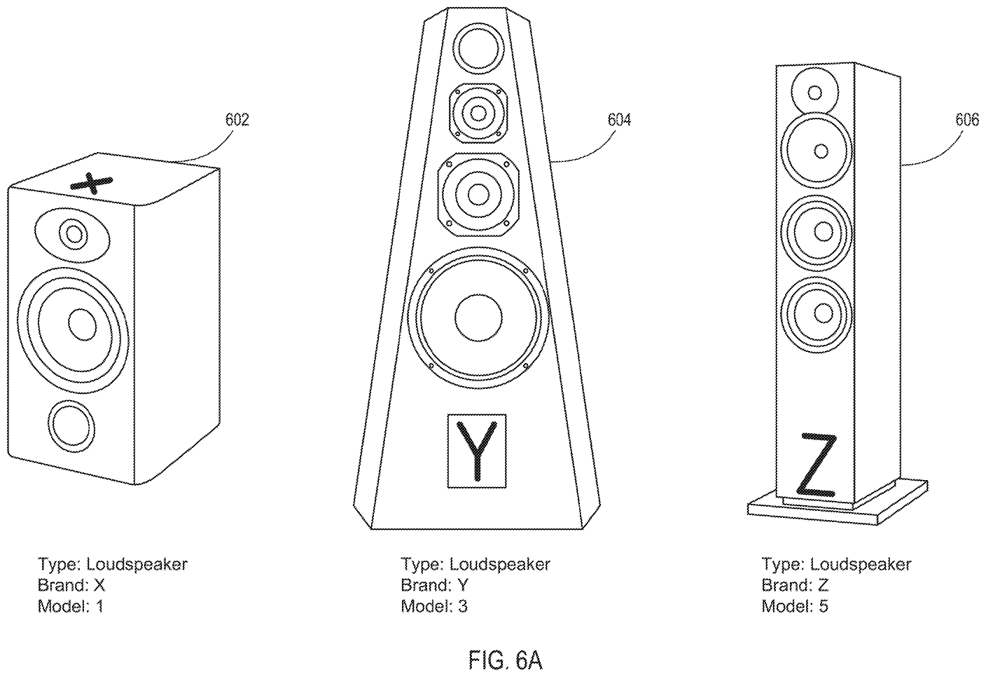

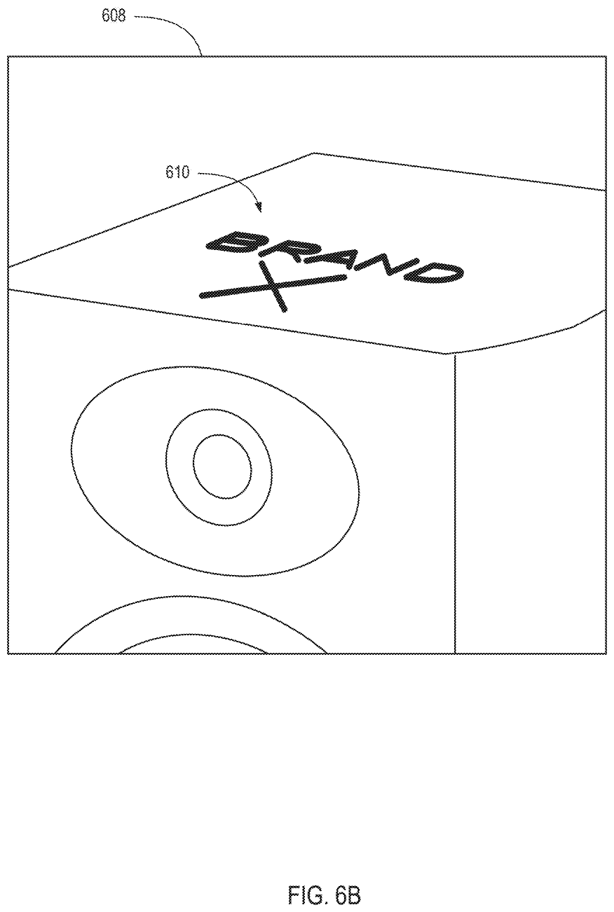

FIG. 6A illustrates examples of several loudspeakers 602, 604, and 606 with various enclosure sizes, enclosure types, driver sizes, brand names, and/or models. In some examples, the enclosure size, enclosure type, driver sizes, brand name, and/or model of a loudspeaker allows for the determination or estimation of the acoustic properties of a loudspeaker. The audio control system may use the known acoustic properties of a loudspeaker to drive outputs in a modified or filtered way to generate a soundfield that approximates or closely mimics the target loudspeaker layout (e.g., one of the standard loudspeaker layouts).

In some examples, a listener, acoustic engineer, setup technician, or another user may manually input the acoustic properties of loudspeakers into an audio control system. Alternatively or additionally, a user may manually provide enclosure sizes, enclosure types, driver sizes, brand names, and/or models of loudspeakers into audio control systems. In some examples, the audio control system may utilize a deep learning model to evaluate images containing loudspeakers of interest to determine the enclosure sizes, enclosure types, driver sizes, brand names, and/or models.

FIG. 6B illustrates an example close-up view 608 of a loudspeaker with its brand name 610 clearly visible. In some examples, an audio control system may utilize the brand name 610 and/or model to determine the loudspeaker's acoustic properties, which may be used to configure the drive outputs to generate a soundfield that more accurately mimics a standard loudspeaker layout. In some examples, loudspeakers may have other identifiable characteristics and/or branding that may be used to determine their acoustic properties. In some examples, loudspeakers may include scannable codes (e.g., barcodes, QR codes, and/or the like) that are visible to users or invisible to users. The audio control system may utilize such codes to determine characteristics of a loudspeaker.

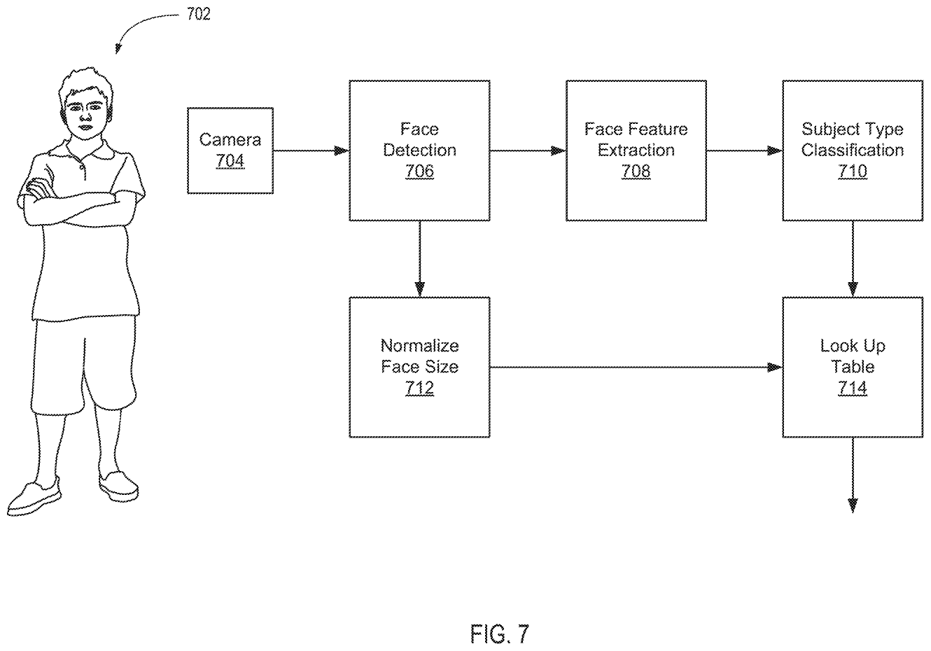

FIG. 7 illustrates a block diagram of an example process that includes a camera 704 to capture an image of an individual or individuals 702. A face detection subsystem 706 detects a face of the user 702 within the captured image. A normalization subsystem 712 normalizes the face size. A facial feature extraction subsystem 708 extracts facial features. A classification subsystem 710 determines subject types (e.g., man, woman, child, etc.). An audio control system may utilize the extracted facial features and the subject type to determine the distance from the camera 704 to individual 702 using a lookup table 714.

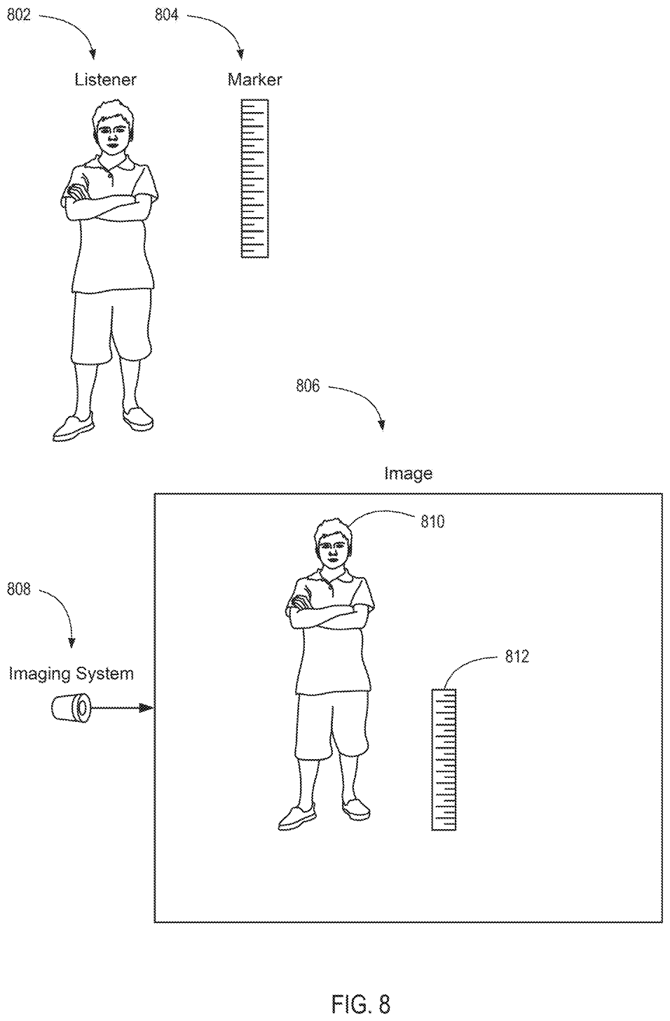

FIG. 8 illustrates an example of a listener 802 and a marker 804 captured in an image 806 by an imaging system 808. In some examples, a marker 812 in the captured image 806 facilitates an accurate distance determination of the user 810 in the captured image 806. The known distances provide a reference that facilitates accurate distance measurements of other objects within the image 806.

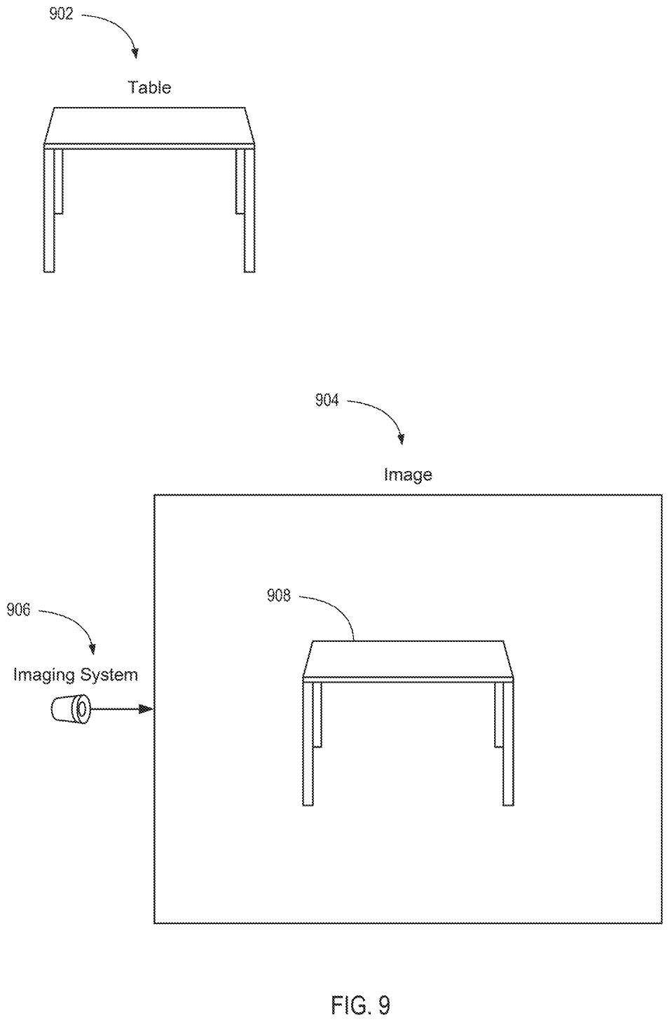

FIG. 9 illustrates an example of a table 902 captured in an image 904 by an imaging system 906. In some examples, a common object, such as a table, with a standard height, provides a reference that facilitates accurate distance measurements of other objects within the image 904.

Specific examples and applications of the disclosure are described above and illustrated in the figures. It is, however, understood that many adaptations and modifications could be made to the precise configurations and components detailed above. In some cases, well-known features, structures, or operations are not shown or described in detail. Furthermore, the described features, structures, or operations may be combined in any suitable manner. It is also appreciated that the components of the examples as generally described and illustrated in the figures herein could be arranged and designed in a wide variety of different configurations. Thus, all feasible permutations and combinations of examples are contemplated.

In the description above, various features are sometimes grouped together in a single example, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed example. Thus, the claims are hereby expressly incorporated into this Detailed Description, with each claim standing on its own as a separate example. This disclosure includes all permutations and combinations of the independent claims with their dependent claims.

What is claimed is:

1. A method, comprising:
capturing, via an imaging sensor, an image of an environment containing loudspeakers connected to an audio control system;
processing, via a processor, the image to identify a user listening position within the environment;
processing the image to identify a physical topographical layout of the loudspeakers relative to the identified user listening position;
identifying a target topographical layout for the loudspeakers relative to the user listening position that is different than the identified physical topographical layout of the loudspeakers; and
modifying drive outputs of the audio control system driving the loudspeakers to modify a soundfield generated by the loudspeakers such that perceived locations of the loudspeakers at the user listening position approximate the target topographical layout.

2. The method of claim 1, wherein processing the image to identify the user listening position comprises a computer-vision analysis of the image to identify one of a couch, a chair, and a person in the image.

3. The method of claim 1, further comprising:
processing the image to identify acoustic characteristics of at least one of the loudspeakers based on one of an enclosure size, a driver size, an identified speaker brand, and an identified speaker model, and
wherein modifying the drive outputs of the audio control system to modify the soundfield is based, at least in part, on the identified acoustic characteristics.

4. The method of claim 3, wherein the identified acoustic characteristics comprise one of a directivity response, an on-axis frequency response, a frequency response, and a sound pressure level (SPL) parameter.

5. The method of claim 1, wherein modifying the drive outputs of the audio control system to modify the soundfield comprises digital filtering and digital equalization prior to digital-to-analog conversion of the drive outputs used to drive the loudspeakers.

6. The method of claim 1, wherein the target topographical layout comprises a loudspeaker layout defined by one of the International Telecommunications Union (ITU), Dolby Laboratories, and THX LTD.

7. An audio control system, comprising:
a processor;
an imaging sensor to capture an image of an environment containing loudspeakers connected to the audio control system;
a listening position subsystem to use the processor to process the captured image to identify a listening position within the environment;
a speaker position subsystem to use the processor to process the captured image to determine a physical location of each loudspeaker relative to the identified user listening position; and
a signal processing subsystem to modify an output signal driving the loudspeakers to steer a soundfield generated by the loudspeakers such that, at the identified user listening position, a perceived location of one of the loudspeakers is mapped to a location that is different than its physical location.

8. The audio control system of claim 7, further comprising:
a distance measurement subsystem to measure a distance from each loudspeaker to the user listening position,
wherein the distance measurement subsystem comprises one of an ultrasonic distance measurement device, an optical time-of-flight measurement device, and a microphone to measure test-tone delays.

9. The audio control system of claim 7, wherein at least two of the loudspeakers are integrated as part of an electronic display.

10. The audio control system of claim 7, wherein the imaging sensor comprises a three-dimensional (3D) imaging sensor, and wherein the image of the environment comprises a 3D image.

11. The audio control system of claim 7, wherein the listening position subsystem and the speaker position subsystem each comprise a trained computer vision module to process the image via a layer-pooling convolutional neural network trained to identify listening positions and user listening positions, respectively.

12. The audio control system of claim 11, wherein the trained computer vision modules of the listening position subsystem and the speaker position subsystem each comprise a marker-based training system, and
wherein the image of the environment captured by the imaging sensor comprises at least one marker to provide spatial context to the marker-based training systems of the listening position subsystem and the speaker position subsystem.

13. A non-transitory computer-readable medium with instructions stored thereon that, when implemented by a processor, perform operations to generate an acoustic filter that modifies a soundfield generated by a plurality of loudspeakers, including a subject loudspeaker, within an environment such that a perceived location of the subject loudspeaker is different than the physical location of the subject loudspeaker, the operations comprising:
processing an image to identify a user listening position within the environment;
processing the image to identify a physical location of each of the loudspeakers, including the subject loudspeaker, within the environment;
identifying a target location for the subject loudspeaker within the environment that is different than the identified physical location of the subject loudspeaker; and
modifying output signals driving at least two of the loudspeakers to modify a soundfield generated by the loudspeakers such that, at the user listening position, a perceived location of the subject loudspeaker approximates the target location.

14. The non-transitory computer-readable medium of claim 13, wherein the image received from the imaging sensor comprises one frame of a video captured by the imaging sensor.

15. The non-transitory computer-readable medium of claim 13, wherein receiving the image from the imaging sensor comprises receiving an image from one of: a camera of a mobile phone of an installer, a camera integrated into an audio video receiver (AVR), a camera integrated into a television, and a repositionable camera communicatively connected to an AVR.
